(19) United States
(12) Patent Application Publication
(10) Pub. No.: US 2026/0342005 A1
(43) Pub. Date: Oct. 29, 2026

(54) ELECTRICAL CONNECTOR AND ELECTRICAL CONNECTOR ASSEMBLY

(71) Applicant: A. RAYMOND ET CIE, GRENOBLE (FR)

(72) Inventors: Anthony SANCHEZ, ST-MARTIN-LE-VINOUX (FR); Baojia LIU, Zhenjiang City (CN); Yang LI, Zhenjiang City (CN)

(21) Appl. No.: 19/648,466

(22) Filed: Apr. 15, 2026

(30) Foreign Application Priority Data
Apr. 23, 2025 (FR) 2504320

(51) Int. Cl. H01R 13/627; H01M 50/503; H01M 50/505; H01R 13/11; H01R 13/115; H01R 13/18; H01R 13/64

(52) U.S. Cl. CPC H01R 13/6275; H01R 13/113; H01R 13/115; H01R 13/18; H01R 13/6272; H01R 13/64; H01M 50/503; H01M 50/505

(57) ABSTRACT

An electrical connector and electrical connector assembly including the electrical connector. The connector is adapted to be mounted on a mounting seat with an activation part to connect with a terminal, and includes: a housing; a clamping unit, which is constructed to clamp the terminal; and an operating member, which is capable of moving relative to the housing between a first position and a second position and is operatively associated with the clamping unit. The clamping unit is capable of switching between an initial state and a working state. The clamping unit switches from the initial state to the working state in response to the operating member moving from the first position to the second position. The electrical connector and electrical connector assembly allow the connector to be connected and disconnected with the terminal multiple times without easily damaging the terminal, and can also prevent accidental operation of the operating member.

### CROSS-REFERENCE TO RELATED APPLICATION

This application is based on and claims priority under 35 U.S.C. § 119 to French Patent Application No. 2504320, filed on Apr. 23, 2025, in the French National Intellectual Property Office, the disclosure of which is incorporated by reference herein in its entirety.

### BACKGROUND

### 1. Field

The present disclosure generally relates to the field of electrical connector technology, and more specifically relates to an electrical connector and an electrical connector assembly including the electrical connector.

### 2. Prior Art

The power system of electric vehicles typically includes multiple batteries. These batteries can be integrated into the vehicle body in different ways. In traditional schemes, these batteries can be connected in series and/or parallel to form multiple battery modules, which are further connected in series and/or parallel to form a battery pack, and then the battery pack is integrated into the vehicle floor. To improve the utilization of vehicle space and increase battery capacity, more space-efficient battery integration schemes have been developed in recent years, such as the CTP (Cell to Pack) scheme and the CTC (Cell to Chassis) scheme. In the CTP scheme, multiple batteries can be directly connected in series and/or parallel to form a battery pack, which is then integrated into the vehicle floor. In the CTC scheme, multiple batteries can be connected in series and/or parallel and directly integrated into the vehicle floor frame.

Typically, the series and/or parallel connections between multiple batteries and/or multiple battery modules are achieved through busbars. The two ends of the busbar are usually connected to the electrical terminals of two batteries and/or battery modules by bolts or welded to the electrical terminals of two batteries and/or battery modules, but this electrical connection operation is time-consuming. Currently, some pluggable electrical connection devices for connecting batteries and/or battery modules have been developed, such as the pluggable module connector disclosed in WO2019242917A1.

It is desirable to develop an electrical connector for connecting electrical terminals of batteries and/or battery modules with one or more of the following features: compact structure, ability to connect and disconnect with the electrical terminal multiple times without easily damaging the electrical terminal, simple connection operation, ability to achieve a secure connection with the electrical terminal, and having anti-misoperation/anti-error functions.

### SUMMARY

The purpose of this present disclosure is to solve the problems existing in the above-mentioned prior art and propose an improved electrical connector and an electrical connector assembly including this electrical connector.

To this end, the first aspect of the present disclosure provides an electrical connector. The electrical connector is adapted to be mounted on a mounting seat to electrically connect with an electrical terminal, and includes: a housing; a clamping unit, which is at least partially disposed within the housing, the clamping unit has an electrical connection part; and an operating member, which is capable of moving relative to the housing between a first position and a second position. The operating member is adapted to be in the first position before the electrical connector is mounted on the mounting seat and mechanically interferes with the housing to prevent the operating member from moving towards the second position, and the operating member is adapted to deform due to pressure contact with the mounting seat during the process of mounting the electrical connector on the mounting seat, such that when the electrical connector is fully mounted in the mounting seat, the operating member disengages from mechanical interference with the housing to allow the operating member to move towards the second position. The electrical connection part is adapted to be electrically connected with the electrical terminal when the operating member is in the second position.

Based on the above technical concept, the present disclosure may further include any one or more of the following optional embodiments.

In some optional embodiments, the operating member is operatively associated with the clamping unit; the clamping unit is adapted, when the operating member is in the second position, to enable a more secure electrical connection between the electrical connection portion and the electrical terminal than when in the first position. In some embodiments, the clamping unit is adapted, when the operating member is in the first position, to disengage from the electrical terminal or to clamp the electrical terminal with a first clamping force, and when the operating member is in the second position, to clamp the electrical terminal with a second clamping force, the second clamping force being greater than the first clamping force, so as to establish a more secure electrical connection.

In some optional embodiments, the clamping unit is capable of switching between an initial state and a working state; the clamping unit switches from the initial state to the working state in response to the operating member moving from the first position to the second position along the direction of movement (D).

In some optional embodiments, the operating member is adapted to elastically deform due to pressure contact with the mounting seat during the process of mounting the electrical connector on the mounting seat.

In some optional embodiments, the housing includes a first limiting part, wherein the operating member includes a cantilever, the cantilever includes a second limiting part, wherein the first limiting part is capable of mechanically interfering with the second limiting part when the operating member is in the first position, to prevent the operating member from moving towards the second position.

In some optional embodiments, the first limiting part and the second limiting part include a first limiting surface and a second limiting surface respectively, wherein the first limiting surface is adapted to abut the second limiting surface when the operating member is in the first position, wherein the first limiting surface and the second limiting surface are perpendicular to the direction of movement.

In some optional embodiments, the cantilever includes a fitting part, the mounting seat comprises an activation part, wherein the fitting part is adapted to elastically deform the cantilever in a direction away from the first limiting part due to pressure contact with the activation part during the process of mounting the electrical connector on the mounting seat.

In some optional embodiments, at least one of the activation part and the fitting part includes a slope inclined relative to the mounting direction of the electrical connector on the mounting seat.

In some optional embodiments, the cantilever is at least partially accommodated within the housing, wherein the housing includes a window, wherein the fitting part is adapted to extend into the window to make pressure contact with the activation part, and/or the activation part is adapted to extend into the window to make pressure contact with the fitting part.

In some optional embodiments, the housing includes a first holding part, and the operating member includes a second holding part, wherein the first holding part mechanically interferes with the second holding part when the operating member is in the first position, to prevent the operating member from detaching from the housing.

In some optional embodiments, both the first holding part and the second holding part are in the form of protrusions; or the housing includes a receiving channel for accommodating the operating member, the end of the receiving channel is formed as the first holding part, and the second holding part extends out from the receiving channel and is in the form of a barb.

In some optional embodiments, the direction of movement is in the same direction as the mounting direction of the electrical connector onto the mounting seat.

In some optional embodiments, the clamping unit includes a contact clamp and an elastic clamp, the contact clamp is retained within the housing and constructed to clamp the electrical terminal, the elastic clamp is arranged on the outside of the contact clamp and constructed to clamp the contact clamp, wherein the elastic clamp is fixed to the operating member to move with the operating member, such that: when the operating member is in the first position, the contact clamp is free from the clamping force of the elastic clamp, and when the operating member is in the second position, the contact clamp is subject to the clamping force of the elastic clamp.

In some optional embodiments, the elastic clamp includes a first clamping part and a second clamping part for clamping the contact clamp between them, at least one of the first clamping part and the second clamping part includes a sliding part, wherein the housing includes a guiding part, wherein the sliding part is supported by the guiding part and can slide along the guiding part to change the distance between the first clamping part and the second clamping part, wherein the distance decreases when the operating member moves from the first position to the second position.

In some optional embodiments, the housing includes a receiving chamber with an open end, wherein the operating member is at least partially inserted into the receiving chamber through the open end, wherein when the operating member is in the second position, the operating member covers the open end and the clamping unit is located within the receiving chamber.

In some optional embodiments, the clamping unit includes a contact clamp, the contact clamp is retained within the housing and constructed to clamp the electrical terminal, wherein the operating member is at least partially disposed within the contact clamp and constructed to switch the contact clamp from an open state to a closed state correspondingly when moving from the first position to the second position.

In some optional embodiments, the contact clamp includes a first contact part and a second contact part for clamping the electrical terminal between them, wherein the operating member includes a spacer part, the spacer part is disposed between the first contact part and the second contact part, and wherein the first contact part and the second contact part are in pressure contact with the spacer part when the operating member is in the first position to open the contact clamp, and disengage from contact with the spacer part when the operating member moves to the second position to close the contact clamp.

In some optional embodiments, the spacer part includes an expansion section and a contraction section adjacent to each other in the direction of movement, wherein the first contact part and the second contact part are aligned with and in pressure contact with the expansion section when the operating member is in the first position, and are aligned with the contraction section when the operating member is in the second position.

In some optional embodiments, the clamping unit also includes an elastic clamp, the elastic clamp is arranged on the outside of the contact clamp and constructed to clamp the contact clamp.

In some optional embodiments, the electrical connector includes at least two clamping units and at least two operating members, each operating member is operatively associated with a corresponding clamping unit, wherein the electrical connector also includes a conductor, the conductor is electrically connected to the contact clamps of the at least two clamping units.

The second aspect of the present disclosure provides an electrical connector assembly, the electrical connector assembly includes a mounting seat and the electrical connector according to the first aspect of the present disclosure, wherein the mounting seat includes an activation part, the electrical connector is adapted to be mounted on the mounting seat to electrically connect with the electrical terminal.

In some optional embodiments, the housing of the electrical connector includes a first latching part, the mounting seat includes a second latching part, wherein the first latching part engages with the second latching part when the electrical connector is fully mounted in the mounting seat, to prevent the electrical connector from detaching from the mounting seat.

In some optional embodiments, the housing includes a wing part, the first latching part is set at the free end of the wing part and is in the form of a barb, wherein the second latching part is in the form of a rib.

In some optional embodiments, the mounting seat is constructed to be suitable for surrounding the electrical terminal.

According to the electrical connector and electrical connector assembly of the present disclosure, the operating member is in the first position when the electrical connector is not yet fully inserted/installed in the mounting seat. At this time, the clamping unit is in the initial state and can be disengaged from the electrical terminal or clamp the electrical terminal with a smaller initial clamping force, thus allowing the electrical terminal to be easily inserted into the clamping unit during the insertion/installation of the electrical connector into the mounting seat, thereby reducing wear on the electrical terminal's conductive plating layer, for example, to allow multiple connections and disconnections between the electrical connector and the electrical terminal. The operating member can move to the second position when the electrical connector is fully inserted/installed in the mounting seat (at this time, the electrical terminal is fully inserted in the clamping unit), enabling the clamping unit to switch to the working state and securely clamp the electrical terminal with a larger working clamping force, thereby achieving reliable mechanical and electrical connection between the electrical connector and the electrical terminal. The operating member can only move towards the second position after the electrical connector is fully inserted/installed in the mounting seat, which can prevent accidental movement of the operating member to the second position during transportation of the electrical connector, and also prevent accidental movement of the operating member to the second position when the electrical terminal is not yet fully inserted in the clamping unit, thus avoiding incorrect connection between the electrical connector and the electrical terminal.

### BRIEF DESCRIPTION OF THE DRAWINGS

Other features and advantages of the present disclosure will be better understood through the following optional embodiments described in detail with reference to the accompanying drawings, in which the same reference numerals identify the same or similar components:

FIG. 1 is a perspective view of the electrical connector assembly according to the first embodiment of the present disclosure applied to a battery module, where the electrical connector of the electrical connector assembly is not yet inserted into the mounting seat;

FIG. 2 is a perspective view of the electrical connector assembly according to the first embodiment of the present disclosure applied to a battery module, where the electrical connector of the electrical connector assembly is fully inserted into the mounting seat, and the electrical connector is electrically connected to the electrical terminal in the mounting seat;

FIG. 3 is a perspective view of the electrical connector of the electrical connector assembly according to the first embodiment of the present disclosure;

FIGS. 4A to 4C are sectional views of the electrical connector of the electrical connector assembly according to the first embodiment of the present disclosure, cut along different planes at the operating member and clamping unit;

FIG. 5 is an exploded view of the electrical connector of the electrical connector assembly according to the first embodiment of the present disclosure;

FIG. 6A is a perspective view of the operating member of the electrical connector of the electrical connector assembly according to the first embodiment of the present disclosure;

FIG. 6B is a sectional view of the first housing body of the housing of the electrical connector of the electrical connector assembly according to the first embodiment of the present disclosure;

FIGS. 7A to 7C are sectional views cut along different planes of the electrical connector assembly according to the first embodiment of the present disclosure when the electrical connector is initially inserted into the mounting seat and the operating member of the electrical connector is in the first position;

FIGS. 8A to 8C are sectional views cut along different planes of the electrical connector assembly according to the first embodiment of the present disclosure when the electrical connector is fully inserted into the mounting seat and the operating member of the electrical connector is in the second position;

FIG. 9 is a perspective view of the electrical connector assembly according to the second embodiment of the present disclosure, where the electrical connector of the electrical connector assembly is not yet inserted into the mounting seat;

FIG. 10 is an exploded view of the electrical connector of the electrical connector assembly according to the second embodiment of the present disclosure;

FIGS. 11A and 11B are different sectional views of a part of the electrical connector of the electrical connector assembly according to the second embodiment of the present disclosure;

FIG. 12A is a perspective view of the first housing body of the housing of the electrical connector of the electrical connector assembly according to the second embodiment of the present disclosure;

FIG. 12B is a perspective view of the operating member of the electrical connector of the electrical connector assembly according to the second embodiment of the present disclosure;

FIGS. 13A and 13B are perspective views of the contact clamp and elastic clamp of the electrical connector of the electrical connector assembly according to the second embodiment of the present disclosure;

FIGS. 14A to 14C are sectional views cut along different planes of the electrical connector assembly according to the second embodiment of the present disclosure when the electrical connector is initially inserted into the mounting seat and the operating member of the electrical connector is in the first position;

FIGS. 15A and 15B are sectional views cut along different planes of the electrical connector assembly according to the second embodiment of the present disclosure when the electrical connector is fully inserted into the mounting seat and the operating member of the electrical connector is in the first position;

FIGS. 16A to 16C are sectional views cut along different planes of the electrical connector assembly according to the second embodiment of the present disclosure when the electrical connector is fully inserted into the mounting seat and the operating member of the electrical connector is in the second position;

FIGS. 17A and 17B are partial perspective view and sectional view of the disassembly process of the electrical connector of the electrical connector assembly according to the second embodiment of the present disclosure, where the operating member of the electrical connector is moved to the first position;

FIGS. 18A and 18B are partial perspective view and sectional view of the disassembly process of the electrical connector of the electrical connector assembly according to the second embodiment of the present disclosure, where the first housing body of the electrical connector is disengaged from the mounting seat; and

FIGS. 19A and 19B show variations of the mounting seat of the electrical connector assembly according to the second embodiment of the present disclosure.

### DETAILED DESCRIPTION

The implementation and use of the embodiments will now be discussed in detail. However, it should be understood that the specific embodiments discussed are only illustrative examples of particular ways of implementing and using the present disclosure, and do not limit the scope of the present disclosure. When describing the structure and position of various components, terms such as up, down, top, bottom, etc. are relative rather than absolute. When the components are arranged as shown in the figures, these positional terms are appropriate, but when the positions of the components in the figures change, these positional terms also change accordingly.

Terms such as “first”, “second”, etc. are used only for descriptive purposes and should not be understood as indicating or implying relative importance or implicitly indicating the number of technical features referred to. In this present disclosure, unless explicitly specified otherwise, terms such as “install”, “connect”, “connect”, “fix”, etc. should be understood broadly. For example, they can refer to fixed connections, detachable connections, or integral connections; they can be directly connected or indirectly connected through intermediate media. For those skilled in the art, the specific meaning of these terms in this present disclosure can be understood according to the specific context.

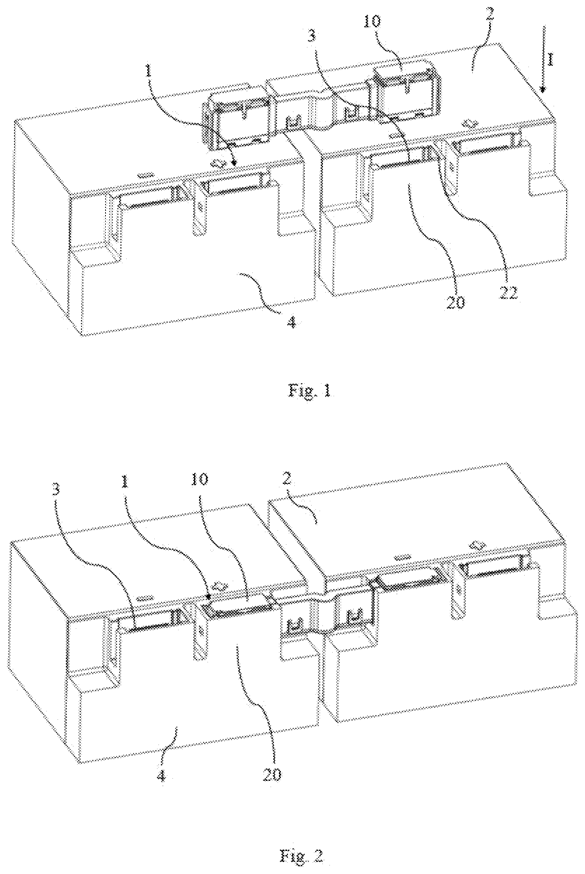

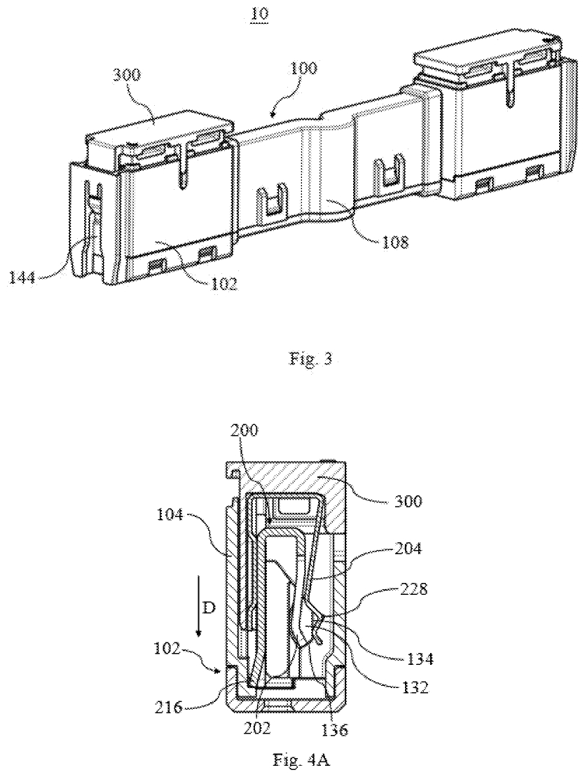

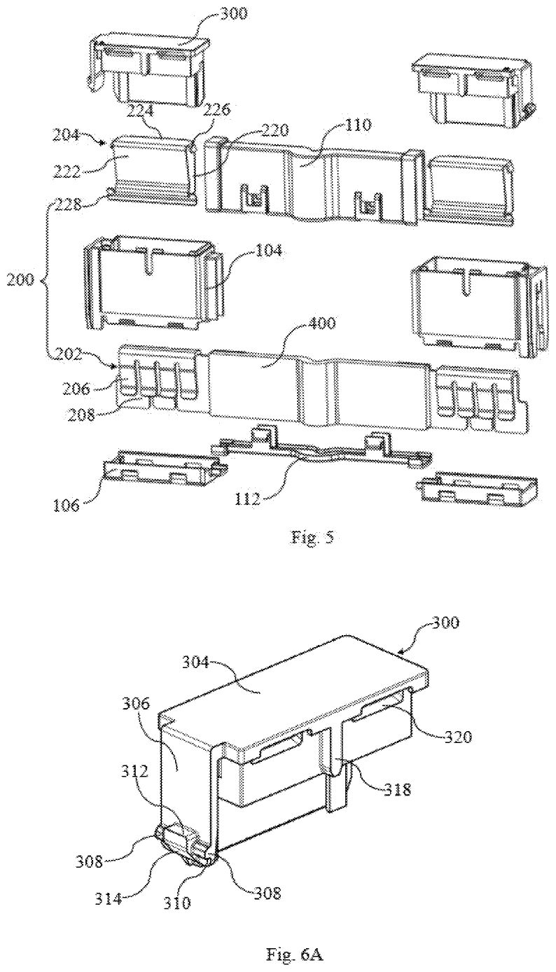

FIGS. 1 to 8C show the electrical connector assembly and its components according to the first embodiment of the present disclosure.

Referring to FIGS. 1, 2 and 7A, the electrical connector assembly 1 may include an electrical connector 10. In the illustrated embodiment, the electrical connector 10 can be used to connect the electrical terminal 3 of the battery module 2 to achieve series or parallel connection between battery modules 2. It can be envisioned that the electrical connector can also be used for electrical connection of electrical terminals of battery cells or other electrical components.

The electrical connector assembly 1 may also include a mounting seat 20. The electrical connector 10 is adapted to be installed/inserted into the mounting seat 20 to electrically connect with the electrical terminal 3. The mounting seat 20 can be set to surround the electrical terminal 3 to prevent accidental contact with the electrical terminal 3 by operators when connecting or disconnecting the electrical connector 10 with the electrical terminal 3, thereby improving the electrical safety of the electrical connector assembly 1. The mounting seat 20 can have a hollow box-like structure and include an activation part/pressing part 21 on the inside, the function of which will be described in detail below. Optionally, the mounting seat 20 can be made of plastic. It can be envisioned that in some other embodiments not shown, the mounting seat may also have other suitable structures as long as it includes an activation part. In the illustrated embodiment, the mounting seat 20 is formed as part of the module end plate 4. It can be envisioned that in some other embodiments, the mounting seat can be separately formed and can be connected to the module end plate or other supporting structure, for example, by welding, snap-fitting, riveting, threaded connection, etc. The electrical terminal 3 can be fixed to the mounting seat 20. Optionally, the electrical terminal 3 can be made of copper or copper alloy. The surface of the electrical terminal 3 may have a conductive plating layer, such as but not limited to a silver plating layer, to reduce contact resistance.

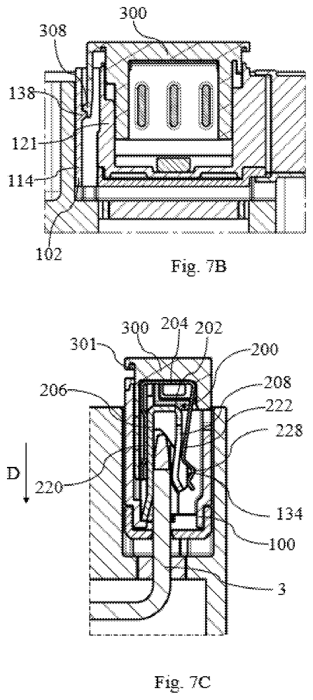

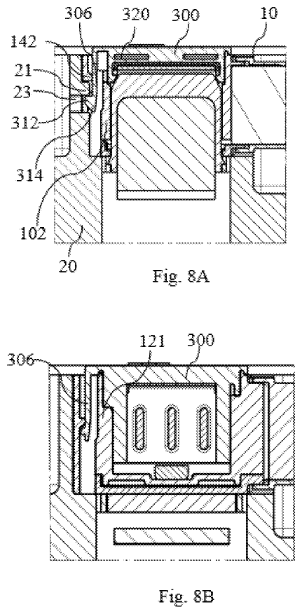

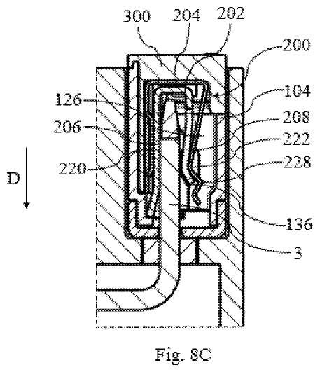

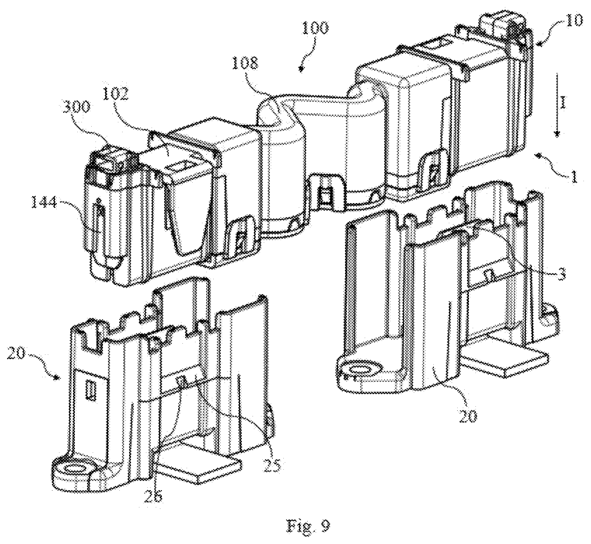

Referring to FIGS. 1 to 3, FIG. 5, and FIGS. 7A to 8C, the electrical connector 10 may include a housing 100, a clamping unit 200, and an operating member 300. The clamping unit 200 is at least partially disposed within the housing 100 and is constructed to clamp the electrical terminal 3 to electrically connect with the electrical terminal 3. The operating member 300 is capable of moving relative to the housing 100 between a first position shown in FIGS. 1, 3, and 7A to 7C and a second position shown in FIGS. 2 and 8A to 8C, and is operatively associated with the clamping unit 200. The clamping unit 200 is capable of switching between an initial state shown in FIG. 7C and a working state shown in FIG. 8C. The operating member 300 is adapted to be in the first position before the electrical connector 10 is inserted/installed into the mounting seat 20 and mechanically interferes with the housing 100 to prevent the operating member 300 from moving towards the second position. The operating member 300 is adapted to, preferentially elastically, deform due to pressure contact with the activation part 21 during the process of inserting/installing the electrical connector 10 into the mounting seat 20, such that when the electrical connector 10 is fully inserted/installed in the mounting seat 20, the operating member 300 disengages from mechanical interference with the housing 100 to allow the operating member 300 to move towards the second position. In a preferred embodiment, the operating member 300 is adapted to elastically deform due to pressure contact with the activation part 21 during the process of inserting/installing the electrical connector 10 into the mounting seat 20

In some optional embodiments, the operating member 300 is operatively associated with the clamping unit 200; the clamping unit 200 is adapted, when the operating member 300 is in the second position, to enable a more secure electrical connection between the electrical connection portion and the electrical terminal 3 than when in the first position. In some embodiments, the clamping unit is adapted, when the operating member 300 is in the first position, to disengage from the electrical terminal or to clamp the electrical terminal with a first clamping force, and when the operating member 300 is in the second position, to clamp the electrical terminal with a second clamping force, the second clamping force being greater than the first clamping force, so as to establish a more secure electrical connection for one skilled in the art.

In some optional embodiments, the clamping unit 200 is capable of switching between an initial state and a working state; the clamping unit 200 switches from the initial state to the working state in response to the operating member 300 moving from the first position to the second position along the direction of movement (D).

The operating member 300 of the electrical connector 10 is in the first position when the electrical connector 10 is not yet fully inserted/installed in the mounting seat 20. At this time, the clamping unit 200 is in the initial state and can clamp the electrical terminal 3 with a smaller initial clamping force, thus allowing the electrical terminal 3 to be easily inserted into the clamping unit 200 during the insertion/installation of the electrical connector 10 into the mounting seat 20, thereby reducing wear on the electrical terminal's conductive plating layer. The operating member 300 can move to the second position when the electrical connector 10 is fully inserted/installed in the mounting seat 20, enabling the clamping unit 200 to switch to the working state and securely clamp the electrical terminal 3 with a larger working clamping force, thereby achieving reliable mechanical and electrical connection between the electrical connector 10 and the electrical terminal 3. The operating member 300 can only move towards the second position after the electrical connector 10 is fully inserted/installed in the mounting seat 20, which can prevent accidental movement of the operating member 300 to the second position during transportation of the electrical connector 10, and also prevent accidental movement of the operating member 300 to the second position when the electrical connector 10 is initially inserted into the mounting seat 20 but not fully inserted (at this time, the electrical terminal 3 is not yet fully inserted in the clamping unit 200), thus avoiding incorrect connection between the electrical connector 10 and the electrical terminal 3.

In the illustrated embodiment, the direction of movement D of the operating member 300 from the first position to the second position can be in the same direction as the insertion direction I of the electrical connector 10 into the mounting seat 20. The movement direction D and insertion direction I can both be vertically downward. This way, by applying an external force (e.g., vertically downward pressure) in the same direction to the electrical connector 10 (more specifically, to the top of the operating member 300), the electrical connector 10 can be inserted into the mounting seat 20 and the operating member 300 can be moved from the first position to the second position. This will facilitate automation of the electrical connection operation between the electrical connector 10 and the electrical terminal 3.

Referring to FIGS. 1, 3 and 5, in the illustrated embodiment, the electrical connector assembly 1 may include two mounting seats 20. The electrical connector 10 may include two clamping units 200 and two operating members 300. Each operating member 300 may be operatively associated with a corresponding clamping unit 200. The electrical connector 10 may also include a conductor 400. The conductor 400 may be a busbar. The busbar 400 and the parts of the clamping units 200 that contact the electrical terminals 3 may be made of conductive material. The two ends of the busbar 400 may be mechanically connected and electrically connected to the two clamping units 200 respectively. Each clamping unit 200 may clamp a corresponding electrical terminal 3. In this way, through the busbar 400 and two clamping units 200 of the electrical connector 10, two electrical terminals 3 of, for example, two battery modules 2 can be electrically connected to each other, thereby electrically connecting, for example, two battery modules 2 to each other.

Referring to FIGS. 1, 3 and 5 to 8C, in the illustrated embodiment, the housing 100 may include two first housing bodies 102. Each first housing body 102 may accommodate a corresponding clamping unit 200. Each operating member 300 may be mounted to a corresponding first housing body 102. Each first housing body 102 is adapted to be inserted into a corresponding mounting seat 20. The mounting seat 20 may have a shape matching the first housing body 102. Each first housing body 102 may include a first housing body 104 and a first bottom cover 106. The first bottom cover 106 may be detachably connected to the first housing body 104, for example, by snap-fitting. In the illustrated embodiment, the housing 100 may also include a second housing body 108. The second housing body 108 may accommodate the busbar 400. The second housing body 108 may include a second housing body 110 and a second bottom cover 112. The second bottom cover 112 may be detachably connected to the second housing body 110, for example, by snap-fitting. The housing 100 and operating member 300 may be made of plastic.

It can be envisioned that in some other embodiments not shown, the electrical connector may also include more than two clamping units and more than one busbar, allowing the electrical connector to electrically connect more than two electrical terminals together; correspondingly, the electrical connector may include more than two first housing bodies, more than one second housing body, and more than two operating members; wherein each operating member may be operatively associated with a corresponding clamping unit.

In the illustrated embodiment, the first housing body 104 of each first housing component 102 may have a generally box-like shape and include a first side wall 114, a second side wall 116, a third side wall 118, a fourth side wall 120, and a partition wall 121. The first side wall 114 and the second side wall 116 are opposite to each other, and the third side wall 118 and the fourth side wall 120 are opposite to each other. The first side wall 114, partition wall 121, third side wall 118, and fourth side wall 120 together form/define a receiving channel 122 extending along the movement direction D of the operating member 300, the function of which will be described below. The partition wall 121, second side wall 116, third side wall 118, and fourth side wall 120 together form/define a receiving chamber 126 with an open top to accommodate the corresponding clamping unit 200. The first housing body 104 may also include a connection port 124 adjacent to the second side wall 116 to connect with the longitudinal end of the second housing body 110.

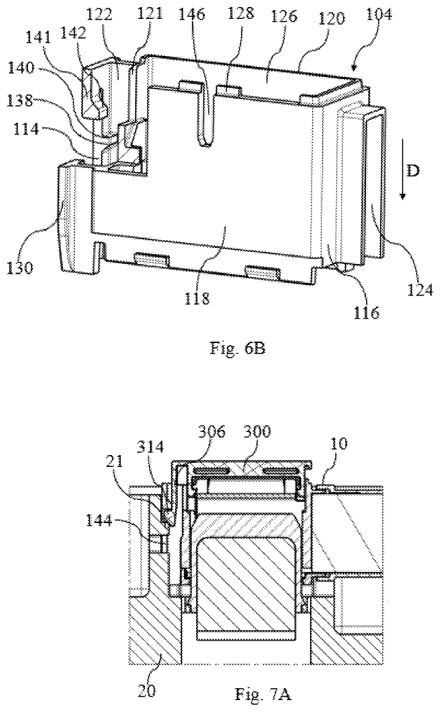

In the illustrated embodiment, as shown in FIG. 8C, when the operating member 300 is in the second position, the operating member 300 covers the open top of the receiving chamber 126 of the first housing body 104 (more specifically, covers the circumferential gap between the operating member 300 and the open top of the receiving chamber 126) and the clamping unit 200 is located within the receiving chamber 126, to prevent accidental contact with the clamping unit 200 by operators and prevent fluids and dust from the outside from entering the interior of the electrical connector 10, thereby improving the electrical safety of the electrical connector 10. In the illustrated embodiment, multiple engaging ribs 128 (see FIG. 6B) may be provided at the top edge of the first housing body 104, and the operating member 300 may correspondingly have multiple engaging notches 301 (see FIG. 7C). Each engaging rib 128 can engage with a corresponding engaging notch 301 when the operating member 300 is in the second position, allowing the operating member 300 to tightly cover the open top of the receiving chamber 126.

In the illustrated embodiment, the first side wall 114 of each first housing component 102 may also include a guiding flange 130 (see FIG. 6B) extending along the insertion direction I of the electrical connector 10. Correspondingly, the mounting seat 20 may include a guiding recess 22 (see FIG. 1) extending along the insertion direction I of the electrical connector 10. During the process of inserting the electrical connector 10 (more specifically, the first housing component 102) into the mounting seat 20, the guiding flange 130 can slide along the guiding recess 22 to guide the electrical connector 10 into the mounting seat 20.

In the illustrated embodiment, the second housing body 110 of the second housing component 108 may have a shape matching the busbar 400, and thus may have a curved structure in its middle portion.

In the illustrated embodiment, the electrical connector 10 has a symmetrical structure. For the sake of clarity and conciseness in the following description, we will mainly describe one of the two first housing components 102 of the electrical connector 10 and its corresponding operating member 300 and clamping unit 200.

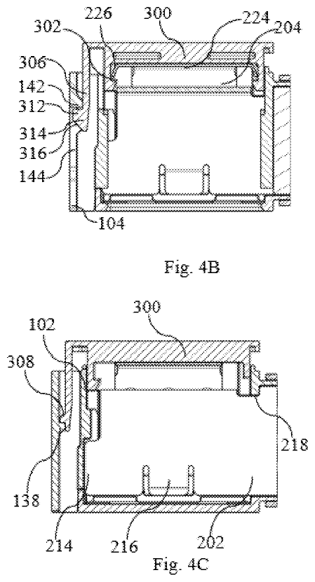

Referring to FIGS. 4A to 8C, in the illustrated embodiment, each clamping unit 200 may include a contact clamp 202 and an elastic clamp 204. In the illustrated embodiment, the contact clamp 202 may be retained within the first housing component 102 and constructed to clamp the electrical terminal 3 to electrically connect with the electrical terminal 3. The elastic clamp 204 may be arranged on the outside of the contact clamp 202 and constructed to clamp the contact clamp 202. The elastic clamp 204 may be fixed to the operating member 300 to move with the operating member 300. As shown in FIG. 7C, when the operating member 300 is in the first position, the elastic clamp 204 is in an open state, and the contact clamp 202 is free from the clamping force of the elastic clamp 204. As shown in FIG. 8C, when the operating member 300 is in the second position, the elastic clamp 204 is in a closed state, and the contact clamp 202 is subject to the clamping force of the elastic clamp 204.

In the illustrated embodiment, the contact clamp 202 may have a generally U-shaped structure and be elastic to provide an initial clamping force. The contact clamp 202 may include a first contact part 206 and a second contact part 208. The first contact part 206 and the second contact part 208 are arranged opposite to each other, for clamping the electrical terminal 3 between them. In the illustrated embodiment, the first contact part 206 includes multiple contact strips, and the second contact part 208 includes a contact sheet. It can be envisioned that in some other embodiments, the contact clamp may have other suitable structures. In the illustrated embodiment, the contact clamp 202 and the busbar 400 are separately formed and connected to each other, for example, by welding or riveting. It can be envisioned that in some other embodiments not shown, the contact clamp and the busbar may be formed as an integral piece. In the illustrated embodiment, each contact clamp 202 and the corresponding first housing component 102 provide limiting structures to limit the movement of the contact clamp 202 relative to the first housing component 102 in various directions, thereby firmly retaining the contact clamp 202 within the first housing component 102. The limiting structures may include, for example, limiting protrusions 214, limiting flanges 216, and limiting grooves 218 on the contact clamp 202, and corresponding structures on the first housing component 102, as shown in FIGS. 4A to 4C. The contact clamp 202 may be made of conductive material, for example, it may be made of copper or copper alloy. Optionally, the contact clamp 202 may be made of pure copper, so that the contact clamp 202 has good conductivity and a relatively small clamping force, to reduce wear on the conductive plating layer on the surface of the electrical terminal 3 when the electrical terminal 3 is inserted into and removed from the contact clamp 202.

In the illustrated embodiment, the elastic clamp 204 may also have a generally U-shaped structure. The elastic clamp 204 includes a first clamping part 220 and a second clamping part 222 for clamping the contact clamp 202 between them. The elastic clamp 204 may include a base part 224 connecting the first clamping part 220 and the second clamping part 222. The elastic clamp 204 may also include a pair of holding lugs 226 symmetrically arranged on opposite sides of the base part 224, and correspondingly, the operating member 300 includes a pair of holding grooves 302, as shown in FIG. 4B. Each holding lug 226 engages with a corresponding holding groove 302, so that the elastic clamp 204 is fixed to the operating member 300. It can be envisioned that in some other embodiments not shown, the elastic clamp may be fixed to the operating member through other suitable holding structures, or the elastic clamp may be formed as an integral piece with the operating member through insert molding. The elastic clamp 204 may be constructed to provide a larger clamping force. The elastic clamp 204 may be made of a material with, for example, a higher elastic limit and higher yield strength, such as spring steel.

At least one of the first clamping part 220 and the second clamping part 222 of the elastic clamp 204 may include a sliding part 228. The first housing body 104 may include a guiding part 132. The sliding part 228 is supported by the guiding part 132 and can slide along the guiding part 132 to change the distance between the first clamping part 220 and the second clamping part 222. The distance between the first clamping part 220 and the second clamping part 222 decreases when the operating member 300 moves from the first position to the second position.

In the illustrated embodiment, the first clamping part 220 is in a generally flat plate shape. The second clamping part 222 is in a bent plate shape and includes two sliding parts 228 set on its opposite sides. Correspondingly, the first housing body 104 includes two guiding parts 132 oppositely arranged inside it. These two guiding parts 132 are set on the partition wall 121 and the second side wall 116 respectively and both protrude towards the receiving chamber 126 of the first housing body 104. Each sliding part 228 is supported by the corresponding guiding part 132 and can slide along the guiding part 132, allowing the operating member 300 to move relative to the first housing body 104 along the movement direction D from the first position to the second position. In the illustrated embodiment, the guiding part 132 includes a first guiding surface 134 and a second guiding surface 136 adjacent to each other. The first guiding surface 134 is closer to the top of the first housing body 104 than the second guiding surface 136. The first guiding surface 134 is parallel to the movement direction D of the operating member 300. The second guiding surface 136 is inclined relative to the movement direction D of the operating member 300. The sliding part 228 abuts the first guiding surface 134 when the operating member 300 is in the first position, as shown in FIG. 7C. The sliding part 228 abuts the second guiding surface 136 when the operating member 300 is in the second position, as shown in FIG. 8C. When the sliding part 228 slides from the first guiding surface 134 to the second guiding surface 136, the distance between the first clamping part 220 and the second clamping part 222 of the elastic clamp 204 decreases. It can be envisioned that in some other embodiments, the sliding part can be set on the first clamping part, or sliding parts can be set on both the first clamping part and the second clamping part.

As shown in FIG. 7C, when the operating member 300 is in the first position, the first clamping part 220 of the elastic clamp 204 contacts the first contact part 206 of the contact clamp 202, the second clamping part 222 of the elastic clamp 204 is supported on the guiding part 132 through the sliding part 228 and basically does not contact the second contact part 208 of the contact clamp 202, the elastic clamp 204 does not apply a loading force/clamping force to the contact clamp 202, at this time, the clamping unit 200 is in the initial state and can clamp the electrical terminal 3 with a smaller initial clamping force provided by the contact clamp 202. As shown in FIG. 8C, when the operating member 300 moves to the second position, the second clamping part 222 of the elastic clamp 204 presses against the second contact part 208 of the contact clamp 202, to apply a loading force/clamping force to the contact clamp 202, at this time, the clamping unit 200 is in the working state and can clamp the electrical terminal 3 with a larger working clamping force jointly provided by the contact clamp 202 and the elastic clamp 204, to achieve a secure connection between the clamping unit 200 and the electrical terminal 3. The contact clamp 202 of the clamping unit 200 can provide good conductivity, while the elastic clamp 204 can provide enhanced clamping force, thus enabling the clamping unit 200 to reliably connect with the electrical terminal 3 with low contact resistance.

Referring to FIGS. 4A to 8C, in the illustrated embodiment, the operating member 300 may include a main body 304 and a cantilever 306 extending from the main body 304. In the illustrated embodiment, the cantilever 306 extends generally along the movement direction D of the operating member 300 and is in the form of a flat strip. The main body 304 is movably accommodated in the receiving chamber 126, and the cantilever 306 is movably accommodated in the receiving channel 122.

In the illustrated embodiment, the housing 100 may include a first limiting part 138. The first limiting part 138 may be in the form of a protrusion and set on the first side wall 114 of the first housing body 104. The cantilever 306 of the operating member 300 may include a second limiting part 308. The second limiting part 308 may be set at the free end of the cantilever 306. The second limiting part 308 may be in the form of a protrusion and protrude towards the first side wall 114. As shown in FIG. 4C, when the operating member 300 is in the first position, the first limiting part 138 can abut the second limiting part 308/mechanically interfere with the second limiting part 308, to prevent the operating member 300 from moving towards the second position. In the illustrated embodiment, the first limiting part 138 and the second limiting part 308 include a first limiting surface 140 and a second limiting surface 310 respectively. When the operating member 300 is in the first position, the first limiting surface 140 can abut the second limiting surface 310, to prevent the operating member 300 from moving towards the second position. The first limiting surface 140 and the second limiting surface 310 may be perpendicular to the movement direction D of the operating member 300, to better prevent the operating member 300 from moving towards the second position. In the illustrated embodiment, the cantilever 306 may include two second limiting parts 308, and correspondingly, the first housing body 104 may include two first limiting parts 138. It can be envisioned that in some other embodiments not shown, the first limiting part and the second limiting part may also have other suitable structures, for example, one of the first limiting part and the second limiting part may be in the form of a protrusion, while the other may be in the form of a notch; in some other embodiments not shown, other suitable numbers of first limiting parts and second limiting parts may be provided.

In the illustrated embodiment, the housing 100 may include a first holding part 142. The first holding part 142 may be in the form of a protrusion and set on the holding arm 141 of the first side wall 114 of the first housing body 104. The cantilever 306 of the operating member 300 may include a second holding part 312. The second holding part 312 may be set at the free end of the cantilever 306. The second holding part 312 may be in the form of a protrusion and protrude towards the first side wall 114. As shown in FIG. 4B, when the operating member 300 is in the first position, the first holding part 142 can abut the second holding part 312/mechanically interfere with the second holding part 312, to prevent the operating member 300 from moving in the direction opposite to the movement direction D and detaching from the first housing component 102. In the illustrated embodiment, the first holding part 142 and the second holding part 312 may be in surface contact with each other, and the contact surface between the first holding part 142 and the second holding part 312 may be generally perpendicular to the movement direction D of the operating member 300, to better prevent the operating member 300 from moving in the direction opposite to the movement direction D and detaching from the first housing component 102. It can be envisioned that in some other embodiments not shown, the second holding part may also not be set on the cantilever of the operating member, but may be set on the main body of the operating member.

In the illustrated embodiment, the cantilever 306 of the operating member 300 may also include a fitting part/pressure-bearing part 314. The fitting part 314 may elastically deform/deflect the cantilever 306 in a direction away from the first limiting part 138, or in other words, elastically deform/deflect away from the first side wall 114 towards the partition wall 121, due to pressure contact with the activation part 21 of the mounting seat 20 during the process of inserting the electrical connector 10 into the mounting seat 20. When the electrical connector 10 (more specifically, the first housing component 102) is fully inserted into the mounting seat 20, the elastic deformation/deflection of the cantilever 306 causes the second limiting part 308 of the cantilever 306 and the first limiting part 138 of the first housing component 102 to disengage from each other, thereby disengaging the operating member 300 from mechanical interference with the first housing component 102 to allow the operating member 300 to move towards the second position. In the illustrated embodiment, both the fitting part 314 and the activation part 21 are in the form of protrusions. In the illustrated embodiment, the fitting part 314 may include a slope 316 (see FIG. 4B) inclined relative to the insertion direction I of the electrical connector 10 into the mounting seat 20, to guide the elastic deformation of the cantilever 306 in a direction away from the first limiting part 138 during the process of inserting the electrical connector 10 into the mounting seat 20. It can be envisioned that in some other embodiments not shown, a slope may be provided on the activation part of the mounting seat, or slopes may be provided on both the activation part of the mounting seat and the fitting part of the cantilever. In the illustrated embodiment, the fitting part 314 and the second limiting part 308 may be adjacent to each other in the width direction of the cantilever 306. In the illustrated embodiment, the fitting part 314 may be located below the second holding part 312.

In the illustrated embodiment, the first side wall 114 of the first housing body 104 may also include a window 144, as shown in FIGS. 4B and 7A. The window 144 may extend along the movement direction D of the operating member 300 and have an open bottom end. The fitting part 314 of the operating member 300 may extend into the window 144. During the process of inserting the electrical connector 10 into the mounting seat 20, the activation part 21 of the mounting seat 20 may also extend into the window 144 to make pressure contact with (in other words, to push against) the fitting part 314 of the operating member 300, thereby causing the cantilever 306 to elastically deform/deflect. The first holding part 142 of the first housing body 104 may be set at the top of the window 144.

In the illustrated embodiment, the first housing body 104 of the housing 100 may include a guiding groove 146 extending along the movement direction D of the operating member 300, see FIG. 6B. The main body 304 of the operating member 300 may include a guiding rib 318 extending along the movement direction D of the operating member 300, see FIG. 6A. As the operating member 300 moves from the first position to the second position, the guiding rib 318 will enter the guiding groove 146 to guide the movement of the operating member 300 along the movement direction D. When the operating member 300 moves to the second position, the bottom end of the guiding rib 318 will abut the bottom end of the guiding groove 146, to prevent the operating member 300 from moving further along the movement direction D.

In the illustrated embodiment, the mounting seat 20 may also include an avoidance part 23. The avoidance part 23 may be in the form of an opening. The avoidance part 23 and the activation part 21 of the mounting seat 20 may be adjacent to each other in the insertion direction I of the electrical connector 10, which is also the movement direction D of the operating member 300. When the operating member 300 moves to the second position, the cantilever 306 of the operating member 300 will recover its shape under the elastic restoring force, allowing the fitting part 314 and the second holding part 312 of the operating member 300 to enter the avoidance part 23, thus allowing the cantilever 306 to return to its stress-free initial state. At the same time, the top edge of the avoidance part 23 and the second holding part 312 can mechanically interfere with/abut each other to prevent the operating member 300 from moving from the second position towards the first position.

In the illustrated embodiment, the main body 304 of the operating member 300 may also include a receiving groove 320, for engaging with a tool (for example, a screwdriver) to remove the electrical connector 10 from the mounting seat 20.

The process of connecting and disconnecting the electrical connector 10 of the electrical connector assembly 1 according to the first embodiment with the electrical terminal 3 will now be described with reference to FIGS. 1 to 8C.

As shown in FIG. 1 and FIGS. 4A to 4C, before the electrical connector 10 is inserted into the mounting seat 20, the operating member 300 of the electrical connector 10 is in the first position. At this time, the first limiting part 138 of the housing 100 abuts the second limiting part 308 of the operating member 300 to prevent the operating member 300 from moving towards the second position, the clamping unit 200 is in the initial state, and the contact clamp 202 is free from the clamping force of the elastic clamp 204.

As shown in FIGS. 7A to 7C, as the electrical connector 10 is gradually inserted into the mounting seat 20 (for example, by pressing down on the operating member 300 to insert the first housing component 102 into the mounting seat 20), the activation part 21 of the mounting seat 20 can make pressure contact with the fitting part 314 of the operating member 300 and guide the cantilever 306 of the operating member 300 to deflect in a direction away from the first limiting part 138 of the housing 100, causing the second limiting part 308 of the operating member 300 to gradually move away from the first limiting part 138 of the first housing component 102, while the electrical terminal 3 can be inserted into the contact clamp 202 with less resistance and is subject to a smaller initial clamping force provided by the contact clamp 202.

When the electrical connector 10 is fully inserted into the mounting seat 20, the electrical terminal 3 is fully inserted into the contact clamp 202, and the first limiting part 138 of the first housing component 102 and the second limiting part 308 of the operating member 300 are offset from each other, allowing the operating member 300 to be pressed down to move towards the second position.

As shown in FIGS. 8A to 8C, when the electrical connector 10 is fully inserted into the mounting seat 20 and the operating member 300 moves to the second position, the clamping unit 200 is in the working state, the contact clamp 202 is subject to the clamping force of the elastic clamp 204, causing the electrical terminal 3 to be subject to a larger working clamping force jointly provided by the contact clamp 202 and the elastic clamp 204. At the same time, the second holding part 312 of the operating member 300 mechanically interferes with the top edge of the avoidance part 23 of the mounting seat 20 to prevent the operating member 300 from moving from the second position towards the first position and detaching from the first housing component 102, thereby allowing the electrical connector 10 to reliably mechanically and electrically connect with the electrical terminal 3.

Referring to FIGS. 4A to 4C and FIGS. 7A to 8C, when disassembling the electrical connector 10 from the mounting seat 20, a tool can be inserted into the avoidance part 23 of the mounting seat 20 to cause the cantilever 306 to deflect in a direction away from the avoidance part 23, thereby disengaging the mechanical interference between the top edge of the avoidance part 23 of the mounting seat 20 and the second holding part 312 of the operating member 300, to allow the operating member 300 to move towards the first position relative to the first housing component 102. At the same time, another tool can be inserted into the receiving groove 320 of the operating member 300 to apply an upward force to the operating member 300, causing it to move upward towards the first position. When the operating member 300 moves to the first position relative to the first housing component 102, the second holding part 312 of the operating member 300 can abut the first holding part 142 of the first housing component 102, while the clamping unit 200 can switch to the initial state. Then, by continuing to apply an upward force to the operating member 300, the operating member 300 will move together with the first housing component 102, allowing the electrical connector 10 to be easily pulled out from the mounting seat 20 and the electrical terminal 3 to be pulled out from the clamping unit 200.

Since the resistance from the clamping unit 200 is relatively small when the electrical terminal 3 is inserted into and pulled out from the clamping unit 200, it allows the electrical connector 10 to be connected and disconnected with the electrical terminal 3 multiple times without easily damaging the conductive plating layer on the surface of the electrical terminal 3.

FIGS. 9 to 19C show the electrical connector assembly and its components according to the second embodiment of the present disclosure. The electrical connector assembly according to the second embodiment is similar to the electrical connector assembly according to the first embodiment in terms of the interaction between the operating member 300 and the housing 100 and mounting seat 20. The main difference between the two is in the interaction between the operating member 300 and the clamping unit 200. The following will mainly introduce the differences between the two embodiments, while the similarities will not be described or only briefly described.

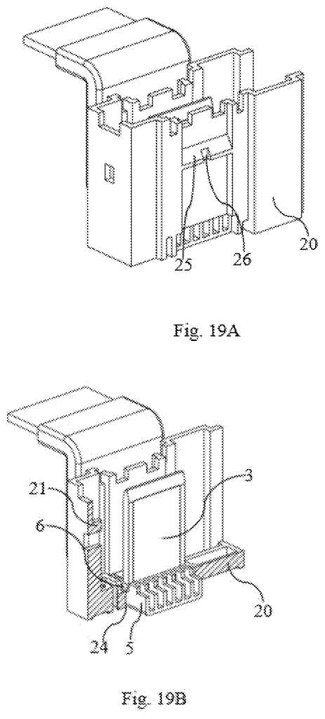

Referring to FIG. 9, FIG. 19A and FIG. 19B, the electrical connector assembly 1 may include an electrical connector 10 and a mounting seat 20. The mounting seat 20 may be set to surround the electrical terminal 3. The mounting seat 20 may have a hollow structure and may include an activation part 21 on its inside. The electrical connector 10 is adapted to be inserted into the mounting seat 20 to electrically connect with the electrical terminal 3. The mounting seat 20 can be separately formed and fixed to the module end plate or other supporting structure, for example, by welding, snap-fitting or bolted connection. In the illustrated embodiment, a mounting frame 5 surrounding the electrical terminal 3 may be formed on the outside of the electrical terminal 3 by injection molding (for example, insert molding). The mounting frame 5 may include a latching protrusion 6 to engage with the latching opening 24 of the mounting seat 20, thereby fixing the electrical terminal 3 to the mounting seat 20.

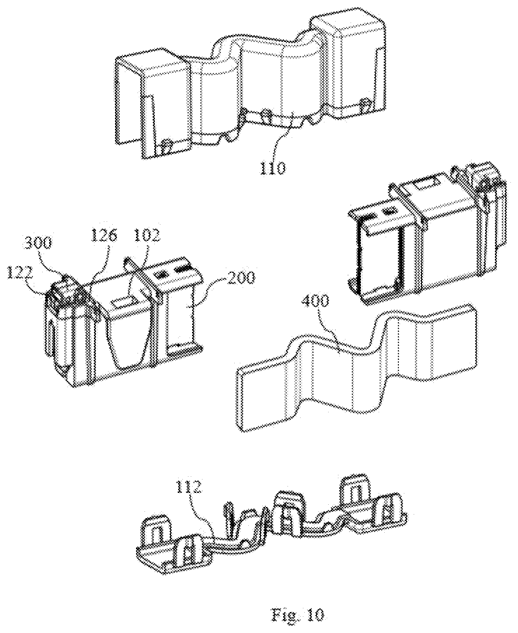

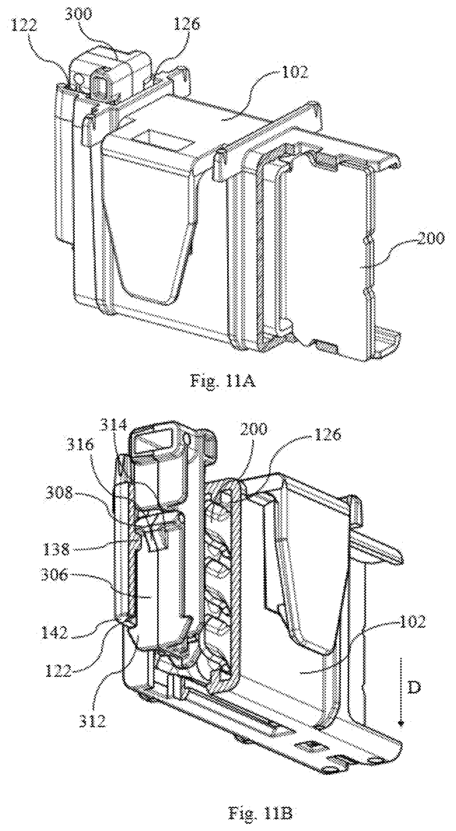

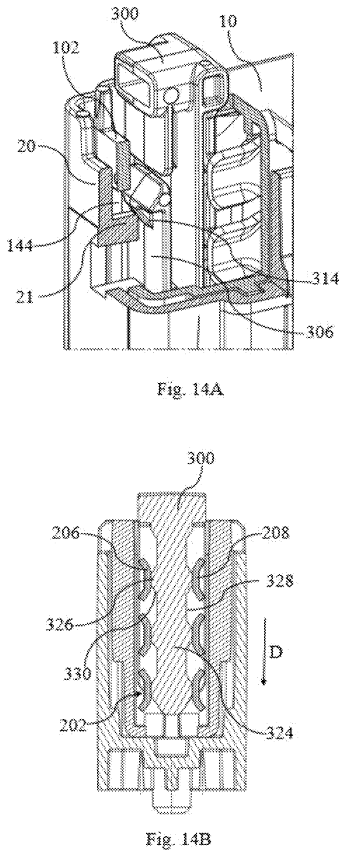

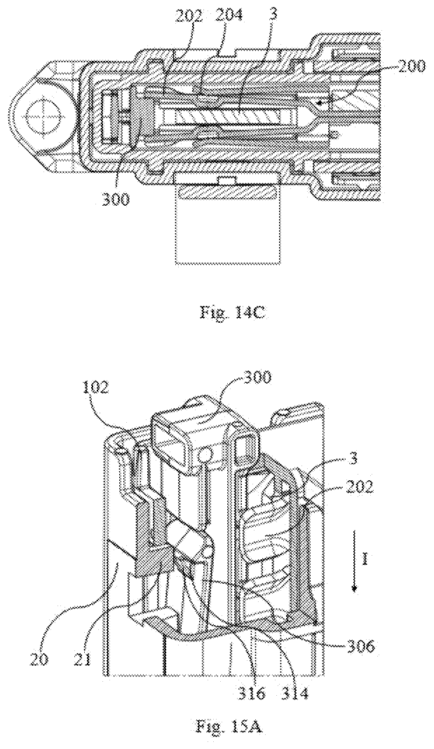

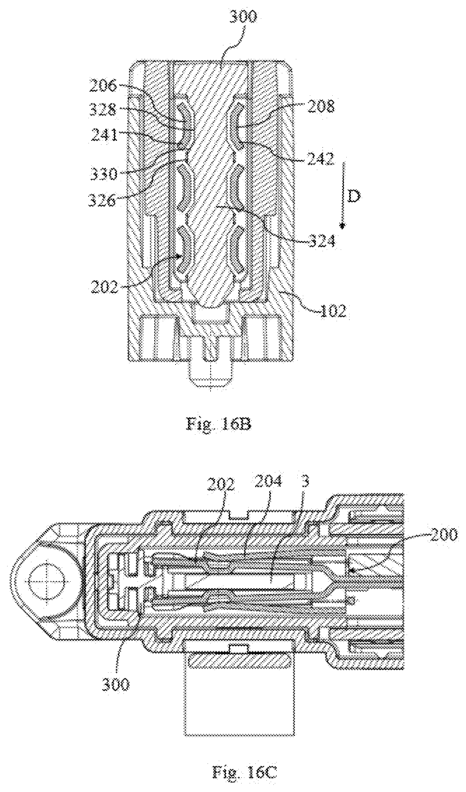

Referring to FIG. 9, FIG. 10 and FIGS. 14A to 16C, the electrical connector 10 may include a housing 100, a clamping unit 200 and an operating member 300. The clamping unit 200 is at least partially disposed within the housing 100 and is constructed to clamp the electrical terminal 3 to electrically connect with the electrical terminal 3. The operating member 300 is capable of moving relative to the housing 100 between a first position shown in FIGS. 11A, 11B and 14A to 15B and a second position shown in FIGS. 16A to 16C, and is operatively associated with the clamping unit 200. The clamping unit 200 is capable of switching between an initial state shown in FIGS. 14B and 14C and a working state shown in FIGS. 16B and 16C. When in the initial state, the clamping unit 200 is adapted to be disengaged from or only slightly in contact with the electrical terminal 3, without applying or almost without applying a clamping force to the electrical terminal 3, and when in the working state, it is adapted to clamp the electrical terminal 3 with a working clamping force. The operating member 300 is adapted to be in the first position before the electrical connector 10 is inserted into the mounting seat 20 and mechanically interferes with the housing 100 to prevent the operating member 300 from moving towards the second position. The operating member 300 is adapted to deform, preferably elastically, due to pressure contact with the activation part 21 during the process of inserting the electrical connector 10 into the mounting seat 20, such that when the electrical connector 10 is fully inserted in the mounting seat 20 (i.e., when the electrical terminal 3 is fully inserted in the clamping unit 200), the operating member 300 disengages from mechanical interference with the housing 100 to allow the operating member 300 to move towards the second position. The clamping unit 200 switches from the initial state to the working state in response to the operating member 300 moving from the first position to the second position along the direction of movement D.

In the illustrated embodiment, the direction of movement D of the operating member 300 from the first position to the second position can be in the same direction as the insertion direction I of the electrical connector 10 into the mounting seat 20. The movement direction D and insertion direction I can both be vertically downward.

Referring to FIGS. 10 to 13B, in the illustrated embodiment, the electrical connector assembly 1 may include two mounting seats 20. The electrical connector 10 may include two clamping units 200 and two operating members 300. Each operating member 300 may be operatively associated with a corresponding clamping unit 200. The electrical connector 10 may also include a conductor 400. The conductor 400 may be a busbar. The busbar 400 and the parts of the clamping units 200 that contact the electrical terminals 3 may be made of conductive material. The two ends of the busbar 400 may be mechanically connected and electrically connected to the two clamping units 200 respectively. Each clamping unit 200 may clamp a corresponding electrical terminal 3. It can be envisioned that in some other embodiments, the conductor may be a cable, braided conductor or other suitable conductor.

In the illustrated embodiment, the housing 100 may include two first housing components 102. Each first housing component 102 may accommodate a corresponding clamping unit 200. Each operating member 300 may be mounted to a corresponding first housing component 102. In the illustrated embodiment, each first housing component 102 may have a generally box-like shape and include a receiving channel 122 and a receiving chamber 126 that communicate with each other. The receiving channel 122 may receive a part of the operating member 300. The receiving chamber 126 may accommodate another part of the operating member 300 and the clamping unit 200. Each first housing component 102 is adapted to be inserted into a corresponding mounting seat 20. The mounting seat 20 may have a shape matching the first housing component 102. In the illustrated embodiment, the housing 100 may also include a second housing component 108. The second housing component 108 may accommodate the busbar 400. The second housing component 108 may include a second housing body 110 and a second bottom cover 112. The second bottom cover 112 may be detachably connected to the second housing body 110, for example, by snap-fitting. The housing 100 and operating member 300 may be made of plastic.

In the illustrated embodiment, the electrical connector 10 has a symmetrical structure. For the sake of clarity and conciseness in the following description, we will mainly describe one of the two first housing components 102 of the electrical connector 10 and its corresponding operating member 300, clamping unit 200 and mounting seat 20.

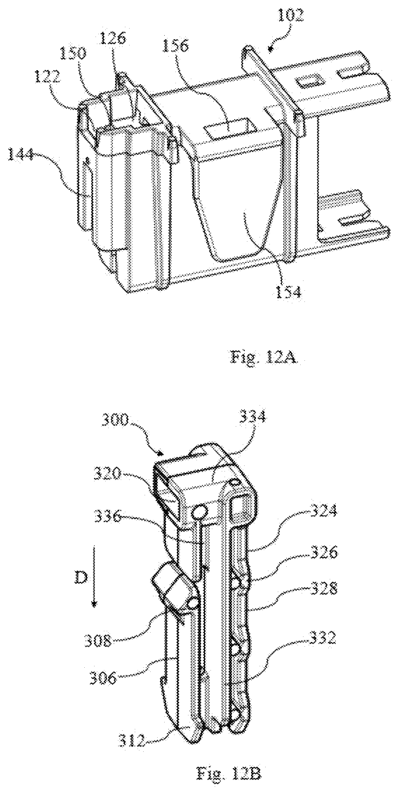

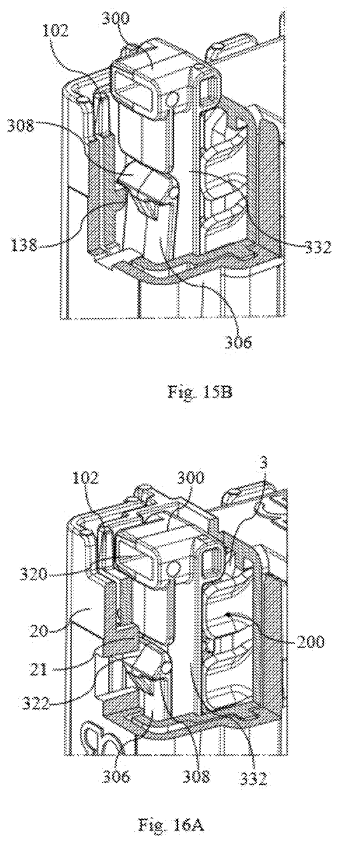

Referring to FIGS. 12B to 16C, in the illustrated embodiment, each clamping unit 200 may include a contact clamp 202 and an elastic clamp 204. The contact clamp 202 is retained within the first housing component 102 and constructed to clamp the electrical terminal 3. The elastic clamp 204 is arranged on the outside of the contact clamp 202 and constructed to clamp the contact clamp 202. The operating member 300 is at least partially disposed within the contact clamp 202 and constructed to switch the contact clamp 202 from the open state shown in FIGS. 14B and 14C to the closed state shown in FIGS. 16B and 16C correspondingly when moving from the first position shown in FIGS. 14A to 15B to the second position shown in FIGS. 16A to 16C. The elastic clamp 204 switches from the open state shown in FIG. 14C to the closed state shown in FIG. 16C correspondingly when the contact clamp 202 switches from the open state to the closed state.

In the illustrated embodiment, the contact clamp 202 may have a symmetrical structure. The contact clamp 202 may include a first contact part 206 and a second contact part 208. The first contact part 206 and the second contact part 208 are arranged opposite to each other, for clamping the electrical terminal 3 between them. The contact clamp 202 and the busbar 400 can be separately formed and connected to each other, for example, by welding. Each contact clamp 202 and the corresponding first housing component 102 provide limiting structures to limit the movement of the contact clamp 202 relative to the first housing component 102, thereby firmly retaining the contact clamp 202 within the first housing component 102. The limiting structures may include, for example, limiting protrusions 230 and limiting notches 232 on the contact clamp 202 and corresponding structures on the first housing component 102. The contact clamp 202 may be made of conductive material, for example, it may be made of copper or copper alloy. Optionally, the contact clamp 202 may be made of pure copper, so that the contact clamp 202 has good conductivity and a relatively small clamping force, to reduce wear on the conductive plating layer on the surface of the electrical terminal 3 when the electrical terminal 3 is inserted into and removed from the contact clamp 202.

In the illustrated embodiment, the elastic clamp 204 may have a symmetrical structure. The elastic clamp 204 may include a first clamping part 220 and a second clamping part 222. The first clamping part 220 and the second clamping part 222 are arranged opposite to each other, for clamping the contact clamp 202 between them. The first clamping part 220 and the second clamping part 222 may press against the first contact part 206 and the second contact part 208 respectively. The elastic clamp 204 may be constructed to provide a larger clamping force. The elastic clamp 204 may be made of a material with, for example, a higher elastic limit and higher yield strength, such as spring steel.

In the illustrated embodiment, the operating member 300 may include a spacer part 324. The spacer part 324 is disposed between the first contact part 206 and the second contact part 208. The first contact part 206 and the second contact part 208 are in pressure contact with the spacer part 324 when the operating member 300 is in the first position to open the contact clamp 202. The first contact part 206 and the second contact part 208 disengage from contact with the spacer part 324 when the operating member 300 moves to the second position, allowing the contact clamp 202 to close under its elastic restoring force.

In the illustrated embodiment, the spacer part 324 may extend generally along the movement direction D of the operating member 300. The spacer part 324 may include an expansion section 326 and a contraction section 328 adjacent to each other in the movement direction D of the operating member 300. In the illustrated embodiment, the expansion section 326 has a constant width. The contraction section 328 has a concave outer contour and thus has a varying width. The width of the expansion section 326 is greater than the minimum width of the contraction section 328. The part of the contraction section 328 adjacent to the expansion section 326 has a sloped surface 330 inclined relative to the movement direction D of the operating member 300.

As shown in FIGS. 14B and 14C, when the operating member 300 is in the first position, the first contact part 206 and the second contact part 208 are aligned with and in pressure contact with the expansion section 326. At this time, the first contact part 206 and the second contact part 208 can elastically deform/deflect towards the outside of the contact clamp 202, causing the contact clamp 202 to be in an open state. When the contact clamp 202 is in the open state, the distance between the first contact part 206 and the second contact part 208 can be greater than or essentially equal to the thickness of the electrical terminal 3, allowing the electrical terminal 3 to be inserted into or removed from the contact clamp 202 without or almost without being subject to the clamping force provided by the contact clamp 202 and the elastic clamp 204, thereby reducing wear on the conductive plating layer on the surface of the electrical terminal 3.

As shown in FIGS. 16A to 16C, when the operating member 300 moves to the second position, the first contact part 206 and the second contact part 208 are aligned with the contraction section 328. At this time, the first contact part 206 and the second contact part 208 can recover their deformation under their own elastic restoring force and the clamping force of the elastic clamp 204, causing the contact clamp 202 to be in a closed state, subjecting the electrical terminal 3 to the working clamping force provided by the contact clamp 202 and the elastic clamp 204, thereby achieving a secure connection between the clamping unit 200 and the electrical terminal 3. At this time, since the electrical terminal 3 is interposed between the first contact part 206 and the second contact part 208, the first contact part 206 and the second contact part 208 can be spaced apart from the contraction section 328.

The contact clamp 202 of the clamping unit 200 can provide good conductivity, while the elastic clamp 204 can provide enhanced clamping force, thus enabling the clamping unit 200 to reliably connect with the electrical terminal 3 with low contact resistance. It can be envisioned that in some other embodiments not shown, if the contact clamp itself has good conductivity and can provide sufficient clamping force, the clamping unit may only include the contact clamp without including the elastic clamp.

In the illustrated embodiment, the first contact part 206 and the second contact part 208 of the contact clamp 202 may include multiple first finger-shaped parts 234 and multiple second finger-shaped parts 236 respectively. The first clamping part 220 and the second clamping part 222 of the elastic clamp 204 may include multiple third finger-shaped parts 238 and multiple fourth finger-shaped parts 240 respectively. Each third finger-shaped part 238 is adapted to press against a corresponding first finger-shaped part 234. Each fourth finger-shaped part 240 is adapted to press against a corresponding second finger-shaped part 236. The spacer part 324 may include multiple expansion sections 326 and multiple contraction sections 328 arranged alternately.

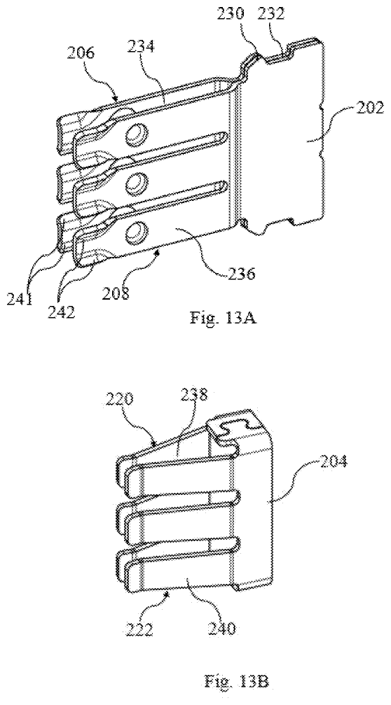

Referring to FIG. 13A and FIG. 14B, when the operating member 300 is in the first position, the free end of each first finger-shaped part 234 and the free end of the corresponding second finger-shaped part 236 are aligned with and in pressure contact with the corresponding expansion section 326, causing the contact clamp 202 to be in an open state. Referring to FIG. 13A and FIG. 16B, when the operating member 300 moves to the second position, the free end of each first finger-shaped part 234 and the free end of the corresponding second finger-shaped part 236 are aligned with and spaced apart from the corresponding contraction section 328, causing the contact clamp 202 to be in a closed state.

In the illustrated embodiment, the free end of each first finger-shaped part 234 and the free end of each second finger-shaped part 236 have a curved profile matching the contraction section 328. The free end of each first finger-shaped part 234 has two side edges 241 inclined relative to the movement direction D of the operating member 300. Each second finger-shaped part 236 has two side edges 242 inclined relative to the movement direction D of the operating member 300. During the process of moving the operating member 300 from the second position towards the first position, the side edges 241 of each first finger-shaped part 234 and the side edges 242 of each second finger-shaped part 236 can slide along the sloped surface 330 of the contraction section 328, allowing the first finger-shaped parts 234 and second finger-shaped parts 236 to easily move away from the contraction section 328 of the spacer part 324 and move to the expansion section 326 of the spacer part 324.

It can be envisioned that in some other embodiments not shown, the contact clamp and elastic clamp may also have other structures, for example, the first clamping part and second clamping part of the elastic clamp may be in the form of flat plates without including finger-shaped parts.

Referring to FIGS. 10 to 13B, in the illustrated embodiment, the operating member 300 may include a central part 332 and a cantilever 306. The spacer part 324 and the cantilever 306 are set on opposite sides of the central part 332 and connected to the central part 332. In the illustrated embodiment, the cantilever 306 extends generally along the movement direction D of the operating member 300 and is in the form of a flat strip. The cantilever 306 and spacer part 324 of the operating member 300 can be accommodated in the receiving channel 122 and receiving chamber 126 respectively. The operating member 300 may also include a head part 334 set at the top of the central part 332. The head part 334 may include a receiving groove 320, for engaging with a tool (for example, a screwdriver) to remove the electrical connector 10 from the mounting seat 20.

In the illustrated embodiment, the first housing component 102 of the housing 100 may include a first limiting part 138. The first limiting part 138 may be in the form of a protrusion and set on the inside of the first housing component 102. The cantilever 306 of the operating member 300 may include a second limiting part 308. The second limiting part 308 may be in the form of a protrusion and set at the top end/free end of the cantilever 306. The first limiting part 138 can abut the second limiting part 308/mechanically interfere with the second limiting part 308 when the operating member 300 is in the first position, to prevent the operating member 300 from moving towards the second position. The first housing component 102 may include two first limiting parts 138, and the cantilever 306 includes one second limiting part 308 to abut the two first limiting parts 138.

In the illustrated embodiment, the first housing component 102 may include a first holding part 142. The bottom end of the receiving channel 122 may be formed as the first holding part 142. The cantilever 306 of the operating member 300 may include a second holding part 312. The second holding part 312 may be set at the bottom end of the cantilever 306. The second holding part 312 may extend out from the receiving channel 122 and be in the form of a barb. The second holding part 312 can hook onto/abut the first holding part 142/mechanically interfere with the first holding part 142 when the operating member 300 is in the first position, to prevent the operating member 300 from moving relative to the first housing component 102 in the direction opposite to the movement direction D and detaching from the first housing component 102, as shown in FIG. 11B.

Referring to FIG. 14A, FIG. 15A and FIG. 15B, in the illustrated embodiment, the cantilever 306 may also include a fitting part 314. The fitting part 314 may elastically deform/deflect the cantilever 306 in a direction away from the first limiting part 138 (in other words, deflect towards the central part 332) due to pressure contact with the activation part 21 during the process of inserting the electrical connector 10 into the mounting seat 20. As shown in FIGS. 15A and 15B, when the electrical connector 10 (more specifically, the first housing component 102) is fully inserted in the mounting seat 20, the elastic deformation/deflection of the cantilever 306 causes the second limiting part 308 of the cantilever 306 and the first limiting part 138 of the first housing component 102 to be offset from each other, thereby disengaging the operating member 300 from mechanical interference with the first housing component 102 to allow the operating member 300 to move towards the second position. In the illustrated embodiment, both the fitting part 314 and the activation part 21 are in the form of protrusions. The fitting part 314 may include a slope 316 inclined relative to the insertion direction I of the electrical connector 10 into the mounting seat 20, to guide the elastic deformation/deflection of the cantilever 306 in a direction away from the first limiting part 138 during the process of inserting the electrical connector 10 into the mounting seat 20.

In the illustrated embodiment, the first housing component 102 may include a window 144. During the process of inserting the electrical connector 10 into the mounting seat 20, the activation part 21 of the mounting seat 20 can extend into and through the window 144 to make pressure contact with the fitting part 314 of the operating member 300, thereby causing the cantilever 306 to elastically deform/deflect.

Referring to FIG. 12A and FIG. 12B, in the illustrated embodiment, the first housing component 102 may include a guiding protrusion 150 on its inside. The operating member 300 may include a guiding channel 336 extending along its movement direction D. As the operating member 300 moves from the first position to the second position, the guiding protrusion 150 will enter the guiding channel 336 to guide the movement of the operating member 300 along the movement direction D. When the operating member 300 moves to the second position, the guiding protrusion 150 will abut the top end of the guiding channel 336, to prevent the operating member 300 from moving further along the movement direction D.

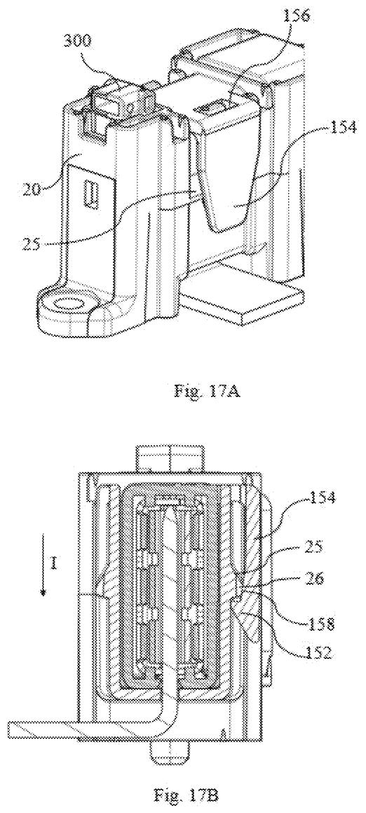

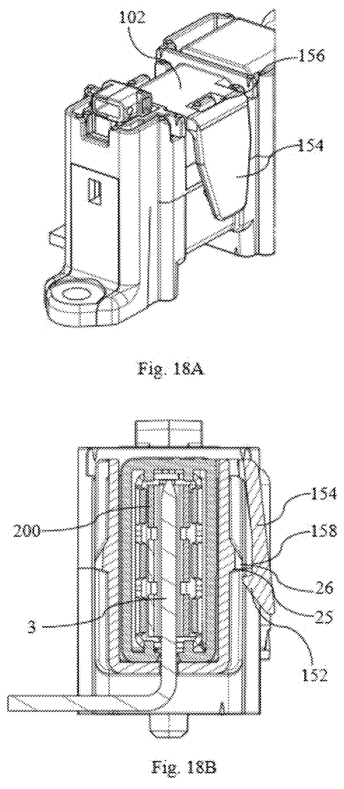

Referring to FIGS. 17A to 18B, in the illustrated embodiment, the first housing component 102 of the electrical connector 10 may also include a first latching part 152. The mounting seat 20 may include a second latching part 25. The first latching part 152 engages with the second latching part 25 when the electrical connector 10 is fully inserted in the mounting seat 20, to prevent the electrical connector 10 from moving in the direction opposite to the insertion direction I and detaching from the mounting seat 20. In the illustrated embodiment, the first housing component 102 may include a wing part 154. The first latching part 152 may be set at the free end/bottom end of the wing part 154 and be in the form of a barb. The second latching part 25 may be set on the outside of the mounting seat 20 and be in the form of a rib.

Referring to FIG. 16A, in the illustrated embodiment, the cantilever 306 may also include a pressure-bearing surface 322 inclined relative to the movement direction D of the operating member 300. The pressure-bearing surface 322 may be set on the second limiting part 308. When moving the operating member 300 from the second position towards the first position, a tool can be inserted into the receiving groove 320 of the operating member 300 to apply an upward force to the operating member 300. At this time, the activation part 21 of the mounting seat 20 presses against the pressure-bearing surface 322, causing the cantilever 306 to elastically deform/deflect towards the central part 332 (in other words, elastically deform/deflect in a direction away from the activation part 21 of the mounting seat 20 and the first limiting part 138 of the first housing component 102), to allow the second limiting part 308 on the cantilever 306 to move past the first limiting part 138 on the first housing component 102, thereby allowing the operating member 300 to move to the first position.

Referring to FIGS. 17A to 19A, in the illustrated embodiment, the wing part 154 of the first housing component 102 may include a first receiving notch 156. The second latching part 25 of the mounting seat 20 may include a second receiving notch 26. The first receiving notch 156 and the second receiving notch 26 are aligned with each other and can accommodate a tool (for example, a screwdriver). The part of the wing part 154 opposite to the second receiving notch 26 of the second latching part 25 includes a guiding slope 158. The guiding slope 158 may be inclined relative to the insertion direction of the tool into the first receiving notch 156 and the second receiving notch 26 (which, in the illustrated embodiment, is vertically downward, i.e., in the same direction as the insertion direction I of the electrical connector 10), to guide the wing part 154 to elastically deform or deflect in a direction away from the second latching part 25 when the tool is inserted into the first receiving notch 156 and the second receiving notch 26, thereby disengaging the first latching part 152 from the second latching part 25 and allowing the electrical connector 10 to be removed from the mounting seat 20, as shown in FIG. 18B.

The process of connecting and disconnecting the electrical connector 10 of the electrical connector assembly 1 according to the second embodiment with the electrical terminal 3 will now be described with reference to FIGS. 9 to 18B.

As shown in FIG. 9, FIG. 11B, FIG. 14B and FIG. 14C, before the electrical connector 10 (specifically, the first housing component 102) is inserted into the mounting seat 20, the operating member 300 of the electrical connector 10 is in the first position. At this time, the first limiting part 138 of the first housing component 102 abuts the second limiting part 308 of the operating member 300 to prevent the operating member 300 from moving towards the second position, and both the contact clamp 202 and the elastic clamp 204 are in the open state.

Referring to FIGS. 14A to 15B, as the electrical connector 10 is inserted into the mounting seat 20, the activation part 21 of the mounting seat 20 can make pressure contact with the fitting part 314 of the operating member 300 and guide the cantilever 306 of the operating member 300 to deflect in a direction away from the first limiting part 138 of the first housing component 102, causing the second limiting part 308 of the operating member 300 to gradually move away from the first limiting part 138 of the first housing component 102. At the same time, the electrical terminal 3 can be easily inserted into the contact clamp 202 which is in the open state, without or almost without being subject to the clamping force of the contact clamp 202.

As shown in FIGS. 15A, 15B and 17B, when the electrical connector 10 is fully inserted into the mounting seat 20, the electrical terminal 3 is fully inserted into the contact clamp 202, and the first latching part 152 of the first housing component 102 engages with the second latching part 25 of the mounting seat 20 to prevent the electrical connector 10 from detaching from the mounting seat 20. At the same time, the first limiting part 138 of the first housing component 102 and the second limiting part 308 of the operating member 300 are offset from each other, allowing the operating member 300 to be pressed down to move towards the second position.

As shown in FIGS. 16A to 16C, when the electrical connector 10 is fully inserted into the mounting seat 20 and the operating member 300 moves to the second position, the contact clamp 202 and elastic clamp 204 switch to the closed state, subjecting the electrical terminal 3 to the larger working clamping force jointly provided by the contact clamp 202 and elastic clamp 204, thereby allowing the electrical connector 10 to reliably mechanically and electrically connect with the electrical terminal 3.

Referring to FIGS. 16A to 17B, when disassembling the electrical connector 10 from the mounting seat 20, first a tool can be inserted into the receiving groove 320 of the operating member 300 to apply an upward force to the operating member 300. The pressure contact between the activation part 21 of the mounting seat 20 and the pressure-bearing surface 322 of the second limiting part 308 of the operating member 300 causes the cantilever 306 of the operating member 300 to elastically deform/deflect towards the central part 332 and away from the activation part 21 of the mounting seat 20 and the first limiting part 138 of the first housing component 102, thereby allowing the second limiting part 308 on the cantilever 306 to move past the first limiting part 138 on the first housing component 102, thus enabling the operating member 300 to move from the second position to the first position and the clamping unit 200 to switch from the working state to the initial state. Referring to FIGS. 18A and 18B, then, a tool can be inserted into the first receiving notch 156 of the first housing component 102 and the second receiving notch 26 of the mounting seat 20, causing the first latching part 152 of the first housing component 102 to disengage from the second latching part 25 of the mounting seat 20, thereby allowing the electrical connector 10 to be easily pulled out from the mounting seat 20 and the electrical terminal 3 to be pulled out from the clamping unit 200.

Since the electrical terminal 3 is not subject to or almost not subject to any clamping force from the clamping unit 200 when being inserted into and pulled out from the clamping unit 200, it allows the electrical connector 10 to be connected and disconnected with the electrical terminal 3 multiple times without easily damaging the conductive plating layer on the surface of the electrical terminal 3.

It should also be understood that the various components and features described herein can be made of various materials, including but not limited to polymers, rubbers, metals, and other suitable materials or combinations of materials known to those skilled in the art. The embodiments shown in FIGS. 1 to 19C only illustrate the shape, number, size and arrangement of various optional components of the electrical connector and electrical connector assembly according to the present disclosure, however, they are only illustrative and not limiting, and other shapes, sizes and arrangements can also be adopted without departing from the spirit and scope of the present disclosure.

The technical content and features of this present disclosure have been disclosed above. However, it can be understood that under the inventive concept of this present disclosure, those skilled in the art can easily make modifications, variations and equivalents to these embodiments based on the disclosed content. For example, features shown or described as part of one embodiment can be used together with another embodiment to produce yet another embodiment. This disclosure is intended to cover such modifications, variations and equivalents. The description of the above embodiments is exemplary and not limiting, and the scope of protection of this present disclosure is determined by the claims.

What is claimed is:

1. An electrical connector, characterized in that the electrical connector is adapted to be mounted on a mounting seat to electrically connect with an electrical terminal, and includes:
a housing;
a clamping unit, the clamping unit being at least partially disposed within the housing, the clamping unit has an electrical connection part; and
an operating member, the operating member being capable of moving relative to the housing between a first position and a second position;
wherein the operating member is adapted to be in the first position before the electrical connector is mounted on the mounting seat and mechanically interferes with the housing to prevent the operating member from moving towards the second position, and the operating member is adapted to deform due to pressure contact with the mounting seat during the process of mounting the electrical connector on the mounting seat such that when the electrical connector is fully mounted in the mounting seat, the operating member disengages from mechanical interference with the housing to allow the operating member to move towards the second position; and
wherein the electrical connection part is adapted to be electrically connected with the electrical terminal when the operating member is in the second position.

2. The electrical connector according to claim 1, characterized in that the operating member is operatively associated with the clamping unit;
the clamping unit is adapted, when the operating member is in the first position, to disengage from the electrical terminal or to clamp the electrical terminal with a first clamping force, and when the operating member is in the second position, to clamp the electrical terminal with a second clamping force, the second clamping force being greater than the first clamping force, so as to establish a more secure electrical connection.

3. The electrical connector according to claim 1, characterized in that the clamping unit is capable of switching between an initial state and a working state;
the clamping unit switches from the initial state to the working state in response to the operating member moving from the first position to the second position along the direction of movement.

4. The electrical connector according to claim 1, characterized in that the operating member is adapted to elastically deform due to pressure contact with the mounting seat during the process of mounting the electrical connector on the mounting seat.

5. The electrical connector according to claim 1, characterized in that the housing includes a first limiting part, wherein the operating member includes a cantilever, the cantilever includes a second limiting part, wherein the first limiting part is capable of mechanically interfering with the second limiting part when the operating member is in the first position, to prevent the operating member from moving towards the second position.

6. The electrical connector according to claim 5, characterized in that the first limiting part and the second limiting part include a first limiting surface and a second limiting surface respectively, wherein the first limiting surface is adapted to abut the second limiting surface when the operating member is in the first position, wherein the first limiting surface and the second limiting surface are perpendicular to the direction of movement.

7. The electrical connector according to claim 5, characterized in that the cantilever includes a fitting part, the mounting seat comprises an activation part, wherein the fitting part is adapted to elastically deform the cantilever in a direction away from the first limiting part due to pressure contact with the activation part during the process of mounting the electrical connector on the mounting seat.

8. The electrical connector according to claim 7, characterized in that at least one of the activation part and the fitting part includes a slope inclined relative to the mounting direction of the electrical connector on the mounting seat.

9. The electrical connector according to claim 7, characterized in that the cantilever is at least partially accommodated within the housing wherein the housing includes a window, wherein the fitting part is adapted to extend into the window to make pressure contact with the activation part, and/or the activation part is adapted to extend into the window to make pressure contact with the fitting part.

10. The electrical connector according to claim 1, characterized in that the housing includes a first holding part, and the operating member includes a second holding part, wherein the first holding part mechanically interferes with the second holding part when the operating member is in the first position, to prevent the operating member from detaching from the housing.

11. The electrical connector according to claim 10, characterized in that both the first holding part and the second holding part are in the form of protrusions; or
the housing includes a receiving channel for accommodating the operating member the end of the receiving channel formed as the first holding part and the second holding part extends out from the receiving channel and is in the form of a barb.

12. The electrical connector according to claim 1, characterized in that the direction of movement is in the same direction as the mounting direction of the electrical connector onto the mounting seat.

13. The electrical connector according to claim 1, characterized in that the clamping unit includes a contact clamp and an elastic clamp, the contact clamp is retained within the housing and constructed to clamp the electrical terminal, the elastic clamp is arranged on the outside of the contact clamp and constructed to clamp the contact clamp, wherein the elastic clamp is fixed to the operating member to move with the operating member, such that: when the operating member is in the first position, the contact clamp is free from the clamping force of the elastic clamp, and when the operating member is in the second position, the contact clamp is subject to the clamping force of the elastic clamp.

14. The electrical connector according to claim 13, characterized in that the elastic clamp includes a first clamping part and a second clamping part for clamping the contact clamp between them, at least one of the first clamping part and the second clamping part includes a sliding part, wherein the housing includes a guiding part wherein the sliding part is supported by the guiding part and can slide along the guiding part to change the distance between the first clamping part and the second clamping part, wherein the distance decreases when the operating member moves from the first position to the second position.

15. The electrical connector according to claim 1, characterized in that the housing includes a receiving chamber with an open end, wherein the operating member is at least partially inserted into the receiving chamber through the open end, wherein when the operating member is in the second position, the operating member covers the open end and the clamping unit is located within the receiving chamber.

16. The electrical connector according to claim 1, characterized in that the clamping unit includes a contact clamp, the contact clamp is retained within the housing and constructed to clamp the electrical terminal, wherein the operating member is at least partially disposed within the contact clamp and constructed to switch the contact clamp from an open state to a closed state correspondingly when moving from the first position to the second position.

17. The electrical connector according to claim 16, characterized in that the contact clamp includes a first contact part and a second contact part for clamping the electrical terminal between them, wherein the operating member includes a spacer part, the spacer part is disposed between the first contact part and the second contact part, and wherein the first contact part and the second contact part are in pressure contact with the spacer part when the operating member is in the first position to open the contact clamp, and disengage from contact with the spacer part when the operating member moves to the second position to close the contact clamp.

18. The electrical connector according to claim 17, characterized in that the spacer part includes an expansion section and a contraction section adjacent to each other in the direction of movement, wherein the first contact part and the second contact part are aligned with and in pressure contact with the expansion section when the operating member is in the first position, and are aligned with the contraction section when the operating member is in the second position.

19. The electrical connector according to claim 16, characterized in that the clamping unit also includes an elastic clamp, the elastic clamp is arranged on the outside of the contact clamp and constructed to clamp the contact clamp.

20. The electrical connector according to claim 13, characterized in that the electrical connector includes at least two clamping units and at least two operating members, each operating member is operatively associated with a corresponding clamping unit, wherein the electrical connector also includes a conductor, the conductor is electrically connected to the contact clamps of the at least two clamping units.

21. An electrical connector assembly, characterized in that the electrical connector assembly includes a mounting seat and the electrical connector according to claim 1, wherein the mounting seat includes an activation part, the electrical connector is adapted to be mounted on the mounting seat to electrically connect with the electrical terminal.

22. The electrical connector assembly according to claim 21, characterized in that the housing of the electrical connector includes a first latching part, the mounting seat includes a second latching part, wherein the first latching part engages with the second latching part when the electrical connector is fully mounted in the mounting seat, to prevent the electrical connector from detaching from the mounting seat.

23. The electrical connector assembly according to claim 22, characterized in that the housing includes a wing part, the first latching part is set at the free end of the wing part and is in the form of a barb, wherein the second latching part is in the form of a rib.

24. The electrical connector assembly according to claim 21, characterized in that the mounting seat is constructed to be suitable for surrounding the electrical terminal.
